(19) United States
(12) Patent Application Publication
(10) Pub. No.: US 2016/0224723 A1
(43) Pub. Date: Aug. 4, 2016

(54) METHOD FOR PREDICTING DRUG RESPONSE BASED ON GENOMIC AND TRANSCRIPTOMIC DATA

(71) Applicant: THE TRUSTEES OF COLUMBIA UNIVERSITY IN THE CITY OF NEW YORK, NEW YORK, NY (US)

(72) Inventors: Raul Rabadan, New York, NY (US); Jiguang Wang, New York, NY (US)

(21) Appl. No.: 15/011,309

(22) Filed: Jan. 29, 2016

Related U.S. Application Data
(60) Provisional application No. 62/109,477, filed on Jan. 29, 2015.

(51) Int. Cl. G06F 19/18; G06F 19/28; G06F 19/24

(52) U.S. Cl. CPC G06F 19/18; G06F 19/24; G06F 19/28

(57) ABSTRACT

This disclosed subject matter relates to methods for predicting drug based on genomic and transcriptomic data. The methods prioritize genetic and gene expression features of cancer cell lines that predict drug response, by integrating genomic/pharmaceutical data, protein-protein interaction network, and prior knowledge of drug-targets interaction with the techniques of network propagation.

### CROSS-REFERENCE TO RELATED APPLICATIONS

This application claims priority from U.S. Provisional Application Ser. No. 62/109,477 filed on Jan. 29, 2015, which is incorporated by reference herein in its entirety.

### STATEMENT REGARDING FEDERALLY SPONSORED RESEARCH

This invention was made with government support under Grant Nos. 1R01CA185486-01 and 1R01CA179044-01A1 awarded by the National Institute of Health, and Grant No. UL1 TR00040 awarded by the National Center for Advancing Translational Sciences, National Institute of Health. The government has certain rights in the invention.

### TECHNICAL FIELD

This disclosed subject matter relates to prediction of drug response of cancer cell lines and identification of drugs for the treatment of cancers based on genomic and trascriptomic data.

### BACKGROUND

A goal of precision medicine is to translate data derived from cancer genomes into personalized cancer therapy. To that end, certain computational biologists have sought to relate features of tumor cells to clinical outcomes of anticancer drugs.

Existing data regarding cancer cell lines, indicates that certain genetic and gene expression candidates can be useful in predicting drug response of cancer cells. However, an analytical framework to make accurate predefinition is needed.

### SUMMARY

The presently disclosed subject matter provides methods for predicting drug response in cancer cell lines and can be used to predict optimal therapies for patients with cancer relying on their cancer genomic data. The method can predict responses by prioritizing gene expression features and genetic features of cancer cell lines, and integrating genomic/pharmaceutical data, protein-protein interaction networks, and prior knowledge of drug-targets interaction with the techniques of network propagation.

In an exemplary embodiment, a method for predicting drug response in cancer patients and of cancer cell lines using genomic and expression data is provided. The method can include selecting a drug. The drug can have known targets. For example, the drug can be BMS-754807, an inhibitor of insulin-like growth factor-1R/IR (IGF1R).

The method can include applying a diffusion kernel based on a plurality of proteins/genes in an interaction database to measure the closeness between the first protein and each of the plurality of genes. The interaction database can be the Search Tool for the Retrieval of Interacting Genes/Proteins (“STRING network”) or other protein-protein network. The method can include ranking each of the plurality of genes. Ranking can be based at least in part on the closeness. Ranking can be based at least in part on a spearman correlation. The method can include selecting one or more genes from the ranking, each having a ranking above a threshold.

The method can include predicting a response of cancer patients or cancer cell lines to the drug based on the selected one or more genes. Predicting can include using a machine learning system. The machine learning system can be a least absolute shrinkage and selection operator (“LASSO”) regression. The method can also include bootstrapping.

### BRIEF DESCRIPTION OF THE DRAWING

FIG. 1 provides a Venn graph of CTRP drug features and DGidb drug targets.

FIG. 2 illustrates the average distance between DF of BMS-536924 and DT of BMS-536924 (IGF1R) as compared to random control.

FIG. 3 illustrates physical protein-protein interaction networks of DF and DT of BMS-536924.

FIG. 4 provides a flow chart of an exemplary method of dNetFS.

FIG. 5 illustrates the diffused information flow, where beta equals to 0.01.

FIG. 6 illustrates the diffused information flow, where beta equals to 0.03.

FIG. 7 illustrates mountain plot based parameter selection.

FIG. 8 illustrates the difference between prior feature selection and posterior feature selection.

FIG. 9 provides exemplary receiver operating characteristics (ROC) curves of resistant prediction of BMS-754807.

FIG. 10 provides exemplary ROC curves of sensitive prediction of BMS-754807.

FIG. 11 compares the different performance of methods in predicting resistant cell lines of BMS-754807.

FIG. 12 compares the different performance of methods in predicting sensitive cell lines of BMS-754807.

FIG. 13 illustrates the different performance of methods in predicting sensitive cell lines of dexamethasone.

FIG. 14 illustrates STRING network of the most relevant features selected by bootstrapping.

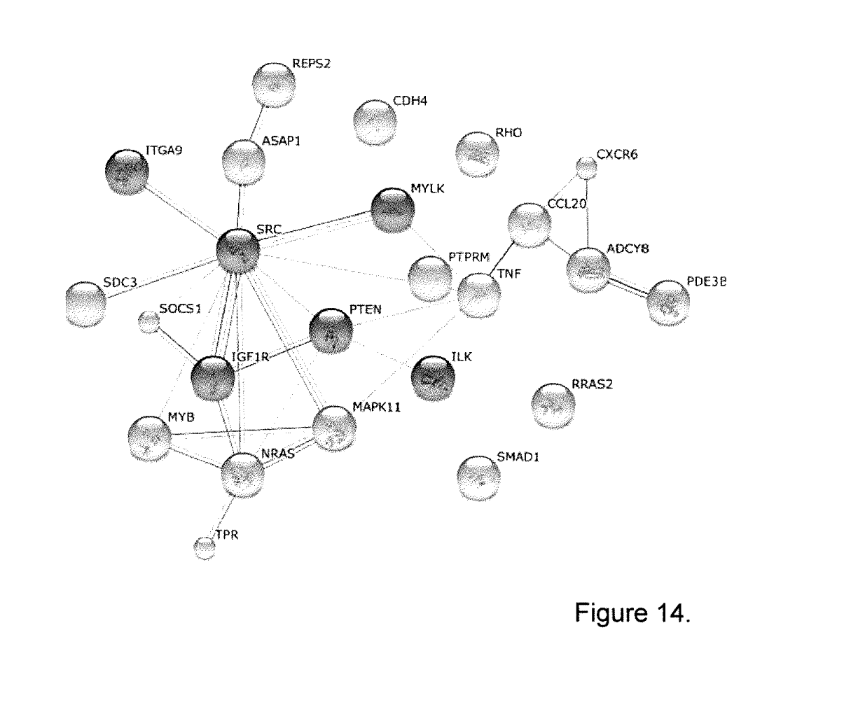

### DETAILED DESCRIPTION

The presently disclosed subject matter provides methods for predicting drug response of cancer cell lines. The method can predict the responses by prioritizing gene expression features and genetic features of cancer cell lines, and integrating genomic/pharmaceutical data, protein-protein interaction networks, and prior knowledge of drug-targets interaction with the techniques of network propagation.

A goal in personalized cancer medicine is to tailor therapeutics and treatments to genetic features harbored by individual cancer cells, usually involved in tumor growth or progression. In certain embodiments, the method can utilize large-scale studies of cancer cell lines as a platform to screen for those drugs while simultaneously inferring their genetic markers. In certain embodiments, subpopulations of different cancer cells within the same patient could be targeted in isolation based on their specific genetic traits.

One challenge of targeted cancer therapy is to relate anticancer drugs to particular cancer cell lines (“CCLs”) characterized by lineage, gene expression and/or other genetic features, including but not limited to single nucleic variations (“SNVs”), small insertions/deletions (“INDELs”), copy number variations (“CNVs”) and structural variations. Certain cancer genome projects such as The Cancer Genome Atlas (“TCGA”), Therapeutically Applicable Research To Generate Effective Treatments (“TARGET”), and International Cancer Genome Consortium (“ICGC”), provide genomic data for many cancers at different levels.

The presently disclosed subject matter includes knowledge-based feature selection methods, e.g., diffusion kernel based Network method for Feature Selection of drug sensitivity (“dNetFS”), to reduce noise by eliminating biologically irrelevant features and to address additional issues. Accumulations of cancer treatment outcomes have generated a large number of hypotheses how mutated genes can be targeted therapeutically or prioritized for drug development, summarized in several well-known databases. The drugable genome can be defined as the genes or gene products that are known to or predicted to interact with drugs, ideally with a therapeutic benefit to patients. In certain embodiments, known anti-cancer drug-targets (DT) from collected databases such as the Drug Gene Interaction database (“DGIdb”) can be used as prior knowledge on the candidate drugs. Prior knowledge, i.e., biological mechanisms, can be applied to select reasonable features to predict drug response.

In certain embodiments, the predicted drug-feature (DF) pairs identified by correlation methods from CTRP can be collected to reveal the association between known DTs and predicted genetic features by simple correlation methods.

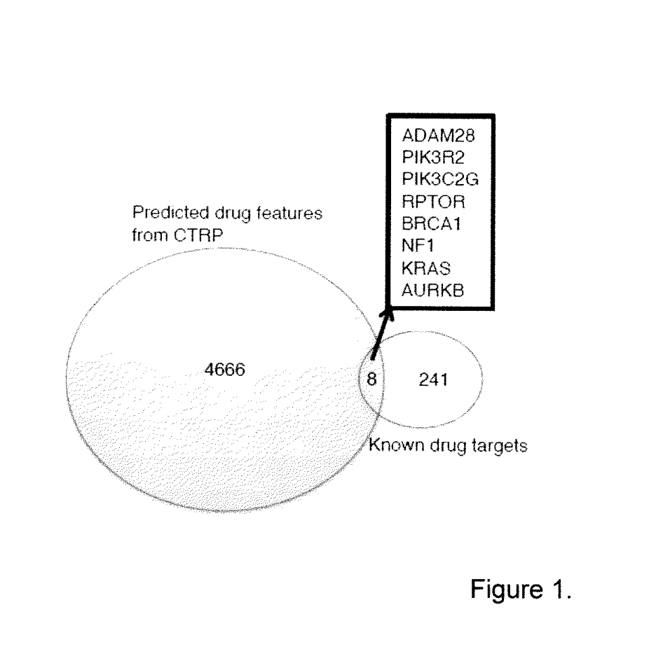

The methods of presently disclosed subject matter can include collecting a list of genes that are predicted to be significantly related to drug sensitivity in at least one subgroup of cancer cell lines for each drug respectively and downloading known drug-gene interactions from the DGIdb, which is a comprehensive collection of available information on the drugable genome. As an example, 35 anticancer drugs in both CTRP and DGIdb can be considered. On average targeted exome sequencing data of more than 100 genes were reported as significant features of sensitive CCLs based on correlation analysis, but very few of them are also known DGIdb drug targets. Summarizing the information for all 35 drugs, only eight out of 4,674 predicted DFs are among the total of 249 known targets (FIG. 1). As a result, systematic follow-up validations of the many identified DFs remain an exception and not the rule.

As DTs and DFs do not overlap well for most of the drugs, it is important to understand whether some of the correlation-based sensitivity features might be close to the known targets in terms of sharing a common pathway or carrying out the same function.

In certain embodiments, the method involves collecting a protein-protein interaction network, representing the functional links between proteins, and investigating how DTs and DFs are related to each other in terms of network topology.

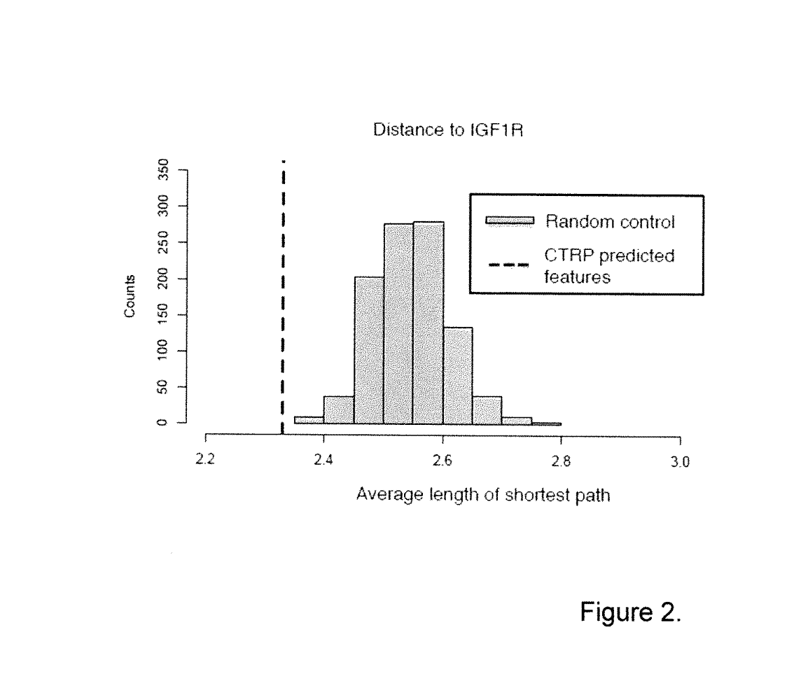

In an exemplary embodiment, anticancer drug, BMS-536924, which is known to inhibit the insulin-like growth factor 1 receptor (IGF1R) and insulin receptor (INSR) is used to illustrate methods of the disclosed subject matter. The direct drug targets of BMS-536924 are not significantly related to drug sensitivity and not labeled DFs in the cell line data. In certain embodiments, the confident interactions (score 700 or higher) of the STRING human protein-protein interaction network, which is an ensemble of different types of known and predicted protein interactions, including direct (physical) and indirect (functional) interactions, are used to test whether there is a potential pathway connecting DFs and DTs. The average length of shortest path between all predicted to the known targets can be calculated based on the STRING network. On average the distance between a DF and DT is 2.33 (marked by a dash line in FIG. 2). In certain embodiments, this distance can be compared with that of randomly picked proteins. In certain embodiments, the comparison can be achieved with generated bootstrapped gene lists (e.g. iteration number n=1000) while requiring accordance of the degree distribution of each list with the predicted feature set. The histogram in FIG. 2 shows the distribution of the average shortest path length of the random control. The observed average distance for the TFs is shorter as expected from the random control based on a normal distribution (p-value<0.0004, FIG. 2).

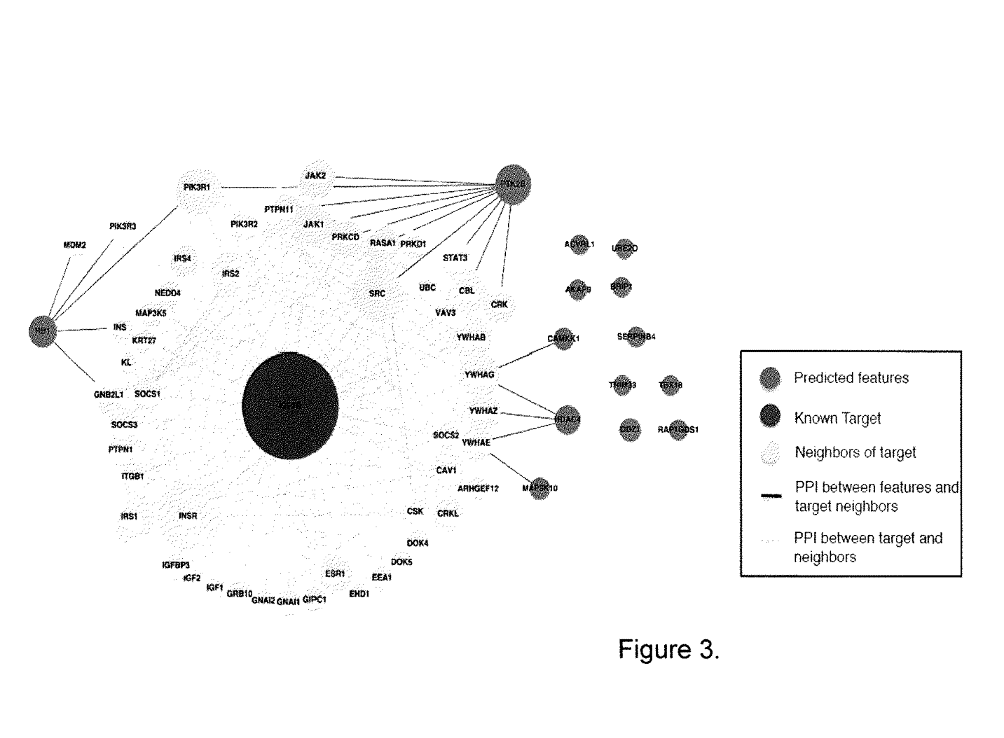

In certain embodiments, the associations of DFs and DTs can be visualized. For example, physical protein-protein interactions of IGF1R, direct neighbors of IGF1R and all genetic DTs of BMS-536924 can be plotted to visualize the associations of IGF1R and BMS-536924 targets, as illustrated in FIG. 3. RBI, PTK2B, CAMKK1, HDAC4, and MAP3K10 have physical interactions with direct neighbors of IGF1R, while ACVRL1, AKAP9, UBE2O, BRIP1, SERPINB4, TRIM33, TBX18, ODZ1, and RAP1GDS1 are not. Based on “guilt by association,” proteins closely connected to IGF1R are more likely to be predictive of the sensitivity of BMS-536924. However, the shortest distance is not necessarily the optimal way to evaluate associations based on network topology.

The above analysis shows that a protein-protein interaction network can represent a biological relevant framework to connect known drug targets and potential features predictive of drug sensitivity. A strong association with known drug targets can also be an indicator of true positive predictions.

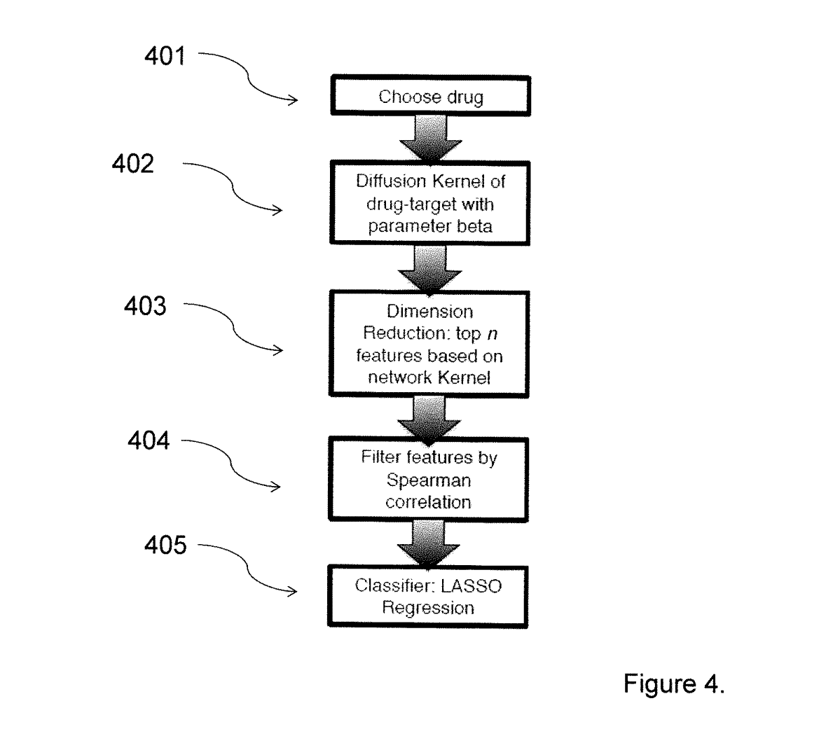

For the purpose of illustration and not limitation, FIG. 4 provides a flow chart of an exemplary method of dNetFS to reduce the feature space based on the underlying protein-protein network surrounding the drug targets. With reference to FIG. 4 for the purpose of illustration and not limitation, in certain embodiments, the method can include choosing a drug target (401) and applying a diffusion Kernel of the drug target with parameter beta (402). Given a drug target, a matrix Kᵢⱼ can be constructed to represent the probability of “information” transferal between the nodes (proteins) i and j in the network. For example, BMS-754807, an inhibitor of insulin-like growth factor-1R/IR (IGF1R), has been screened in the cancer cell line project and inhibits a single known target protein. BMS-754807 is chosen herein for illustrating the presently disclosed subject matter.

In certain embodiments, the diffusion Kernel of the drug-target can be applied according to equation 1:

$$K = {e}^{β H} = I + β H + \frac{{β}^{2}}{2 !} {H}^{2} + … \qquad ( 1 )$$

The diffusion Kernel represents the continuous time limit of a lazy random walk, across the network, starting from the respective drug target node, where H is the negative Laplacian matrix defined on the adjacency matrix as obtained from a protein network, for example, the STRING network. For example, seeding from the protein IGF1R, a diffusion Kernel can be applied based on the STRING network to measure the closeness between IGFIR and any other protein.

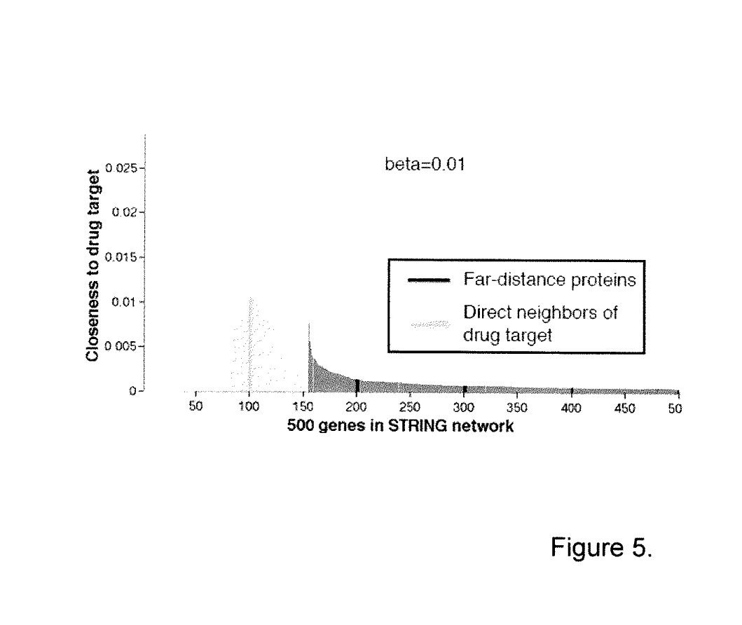

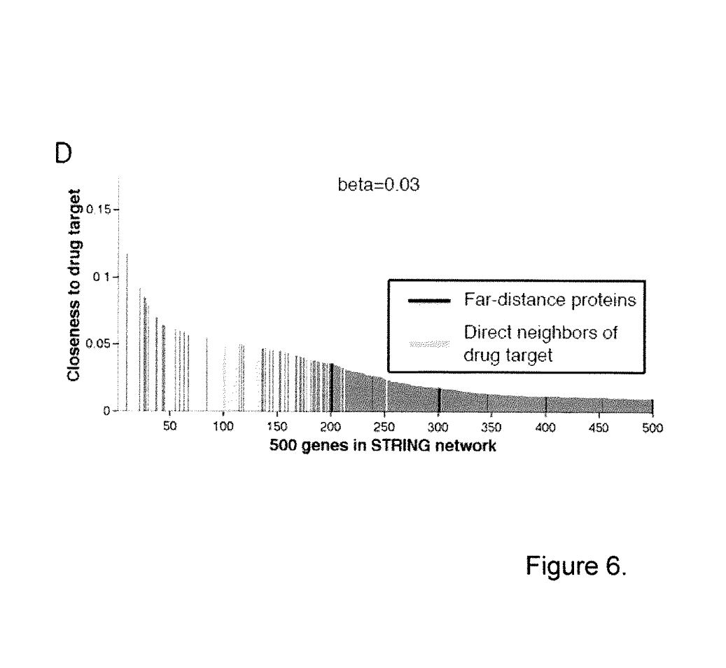

In certain embodiments, dNetFS can have two parameters, beta and n, representing the balance between information spread within the network and number of features to be considered. The Kernel parameter beta indicates the degree of propagation of information flow. If beta is very close to zero, the flow distributes locally around the starting node. In this case, direct neighbors can have higher weight in terms of closeness to the target (See, e.g., FIG. 5). With increasing values of beta, some far-distant nodes become more accessible depending on their centrality in the network topology (See, e.g., FIG. 6). n is the number of features to be considered in the sensitivity prediction.

The Kernel parameter beta allows tuning of the information spread across the network, with parameters much less than one but greater than zero restricting the transferal of “connectivity flow” to nodes close to the target and parameters closer to one allowing wide spread flow over the network. Since the Kernel assigns a probability for each node to be “close” to the target depending on the tuning parameter we can use these probability values to rank the features based on their relatedness to the target. Moreover, the Kernel prioritizes genes having multiple paths to the starting (drug target) node and thus assigns more weight to hub genes and unique, sometimes distant, interaction partners with high target connectivity.

In certain embodiments, to determine the optimal values for beta and n, a score S can be defined on the ranked list of the top Q features being closest to a Kernel with parameter beta:

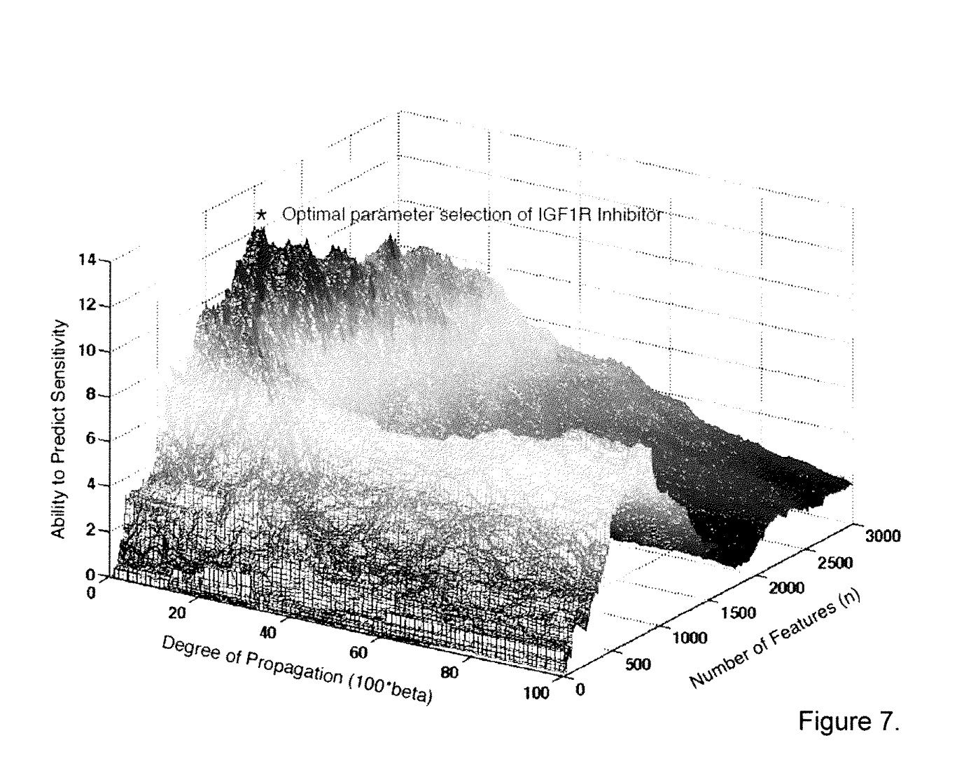

S−−log₁₀[P(ρ(l)>ρ(l̅))] (2)

where l is the number of included features (top l nodes in the network) , l̅ is the number of excluded features (all nodes excluding the l nodes), ρ is the spearman correlation coefficient between included features and drug sensitivity, and P is the p-value calculated by Wilcoxon rank-sum test. The values of n and beta can be optimized by maximizing the value of S. As shown in FIG. 7, the selected features by dNetFS can be predictive to drug sensitivity when beta is less than 0.2 and n is bigger than 500 with p-value less than 10e-8.

For example, in case of BMS-754807, the top 5% closest genes are selected as candidate features. Expression levels of 61 out of 627 candidate features are significantly correlated to drug sensitivity (absolute value of Spearman correlation coefficient>0.25). This is enriched compared to a random control (p-value<2e-13), indicating that features selected based on the network are informative in predicting drug sensitivity. Functional enrichment analysis of those 61 features showed that 26 of them are involved in cell adhesion (related to cancer metastasis), cell migration, and blood vessel development. Tumors that spread through circulatory systems can thus use the mechanism of cell adhesion to establish new tumors in a patient.

With reference again to FIG. 4 for the purpose of illustration and not limitation, the method of the presently disclosed subject matter can further include reducing dimension based on the network Kernel (403), filtering features by spearman correlation (404), and classifying with LASSO regression (405). LASSO regression is an alternative regularized version of the least squares. Given one drug and n different cancer cell lines, if y=(y₁, . . . , yₙ) represents drug sensitivity of different cell lines, and xᵢ=(xᵢ₁, . . . , xᵢₘ)′, (i=1, . . . , n) represents features of ith cell line, the LASSO regression is to solve the following problem:

$${min}_{{α}_{0} , α} ( \frac{1}{2 n} {\sum }_{i = 1}^{n} {( {y}_{i} - {α}_{0} - {x}_{i}^{′} α )}^{2} + λ {\sum }_{j = 1}^{m} \vert {α}_{j} \vert ) \qquad ( 3 )$$

where λ is a nonnegative regularization parameter.

Correction methods (e.g. Pearson correlation or spearman correlation) can be used to select features in CCLE and CTRP. With a given set of selected features, Lasso regression model can be applied to minimize the sum of squared errors, and also the sum of the absolute values of the coefficients of all features. Although cross-validation analysis showed that the correlation-based features could obtain high accuracy in predicting cell line response, the sensitivity and specificity of these methods can be over-estimated as the testing set is not removed during feature selection.

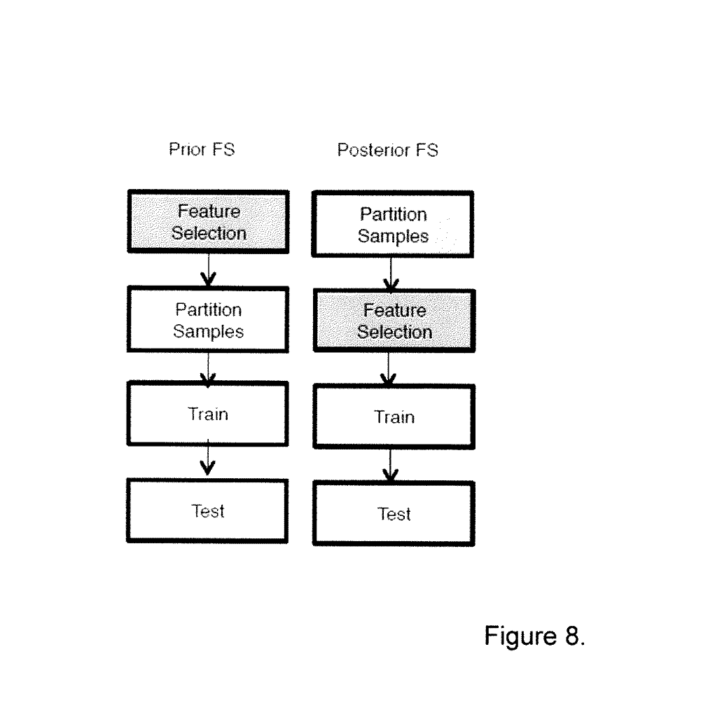

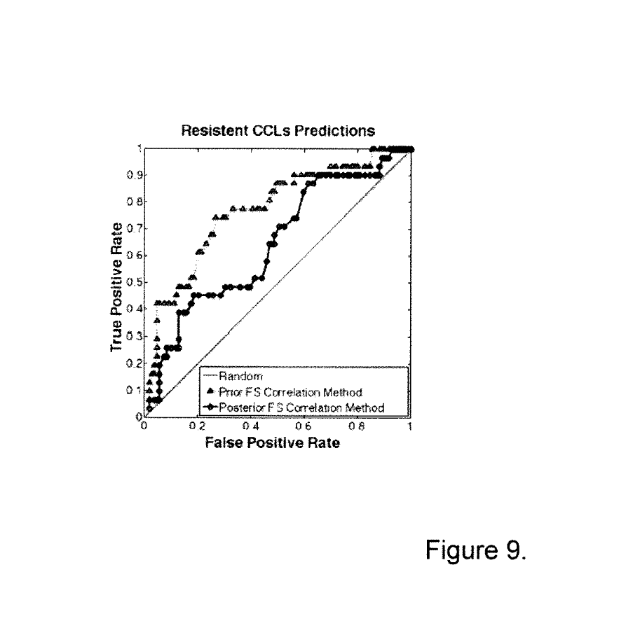

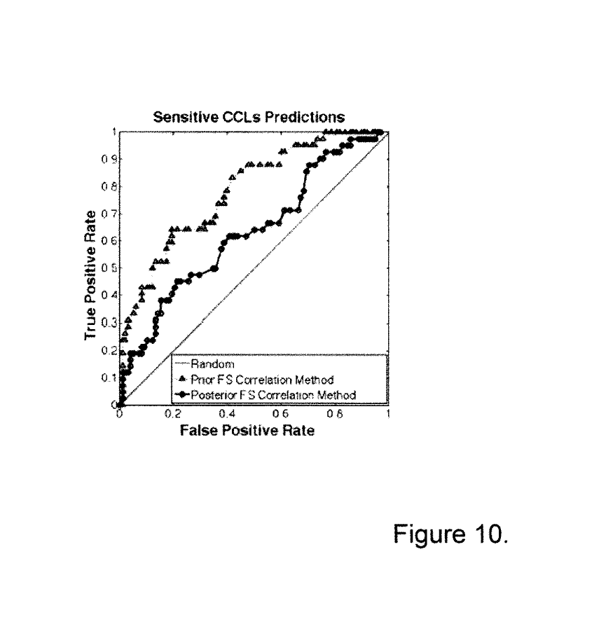

As shown in FIG. 8 for the purpose of illustration and not limitation, “prior” feature selection uses the information of both training and testing samples to select informative features, while “posterior” feature selection chooses features based exclusively on the information content of the training samples. The impact feature selection can have on the predictive power of Lasso regression is demonstrated in FIGS. 9 and 10 using the Drug Response data for 140 available CCLs of BMS-754807. For all cell lines, prior feature selection and posterior feature selection methods can be carried out as follows. In the first method (prior), feature selection is based on all 140 CCLs and a cutoff of bigger than 0.25 absolute spearman correlation is used to reduce the feature space. Subsequently, each CCL is sequentially removed from the set, leaving 139 CCLs for training of the Lasso model. Drug response of the excluded CCL is then predicted based on the trained model. After obtaining a predicted value for each of the 140 CCLs respectively, the receiver operating characteristics (ROC) curve is computed for both sensitivity and resistance, where resistance of a cell line is defined by an area under the drug-response curve (AUC) bigger than 5.5 (total of 31 CCLs are resistant) and sensitive by an AUC value smaller than 3.5 (total of 42 CCLs). The same strategy can also be applied for the posterior feature selection method where the single cell line is removed before feature space reduction. In both cases, resistance and sensitivity, the predictive power of the posterior method decreases. This result further underlines the insufficient size of the covered sample space to adequately capture complex cancer traits.

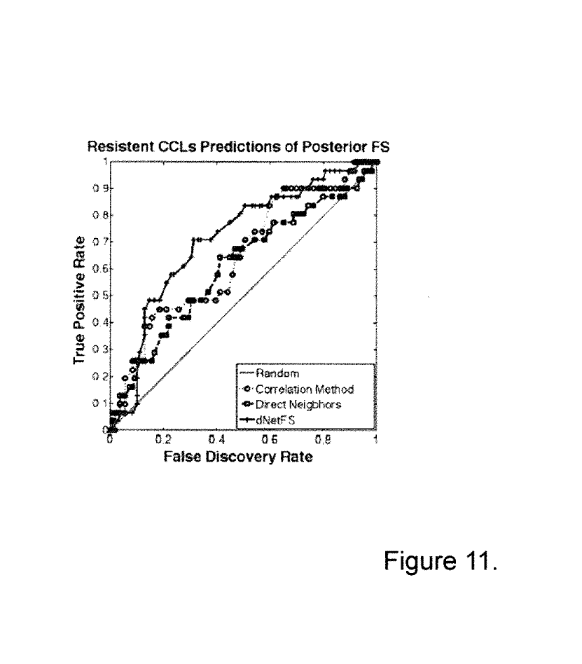

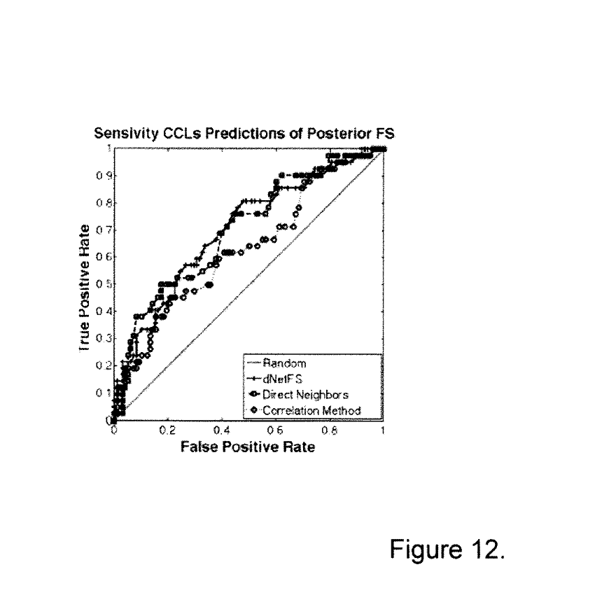

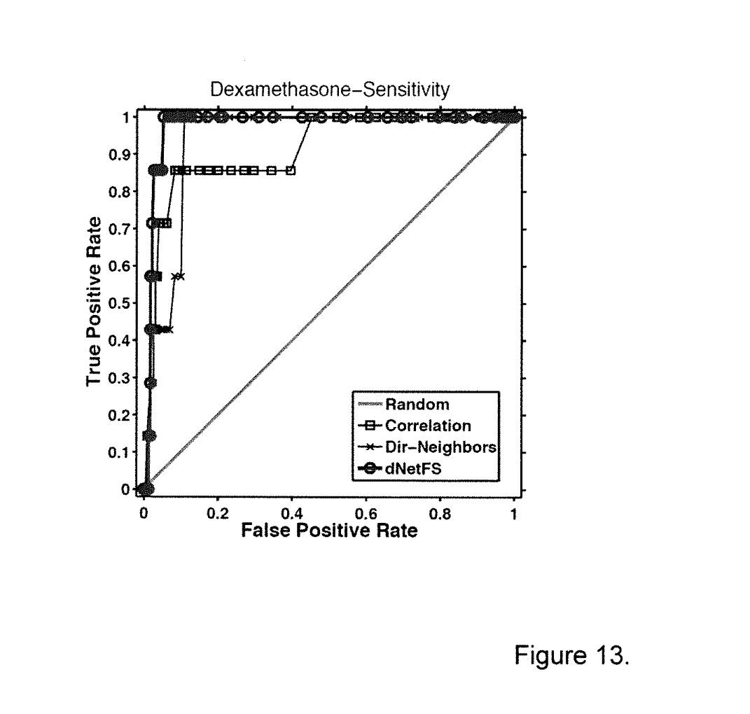

Based on the above reasoning that genetic features should be physically close to known drug targets in order to be biological relevant, dNetFS can be applied as a means to reduce the feature space. As an example, performance of LASSO regression predictions for the drug BMS-754807 for dNetFS -based feature selection can be compared to Spearman correlation based selection and an approach where only the direct neighbors of the drug target were included. DNetFS outperforms the other two methods in predicting resistant cell lines of BMS-754807 (See FIG. 11). Using dNetFS can improve the prediction for sensitive cell lines of BMS-754807, compared to the Spearman correlation method, and perform as well as applying a direct neighbor approach (FIG. 12). As another example, the method can be applied to predict sensitivity of dexamethasone, known to target the glucocorticoid receptor (NR3C1). 237 CCLs have been tested against dexamethasone in CCLE project. An improved feature set for drug dexamethasone contains 899 genes, and the ROC curve is shown in FIG. 13.

In certain embodiments, genetic features can be ranked based on their frequency of being selected in the Lasso regression to evaluate features by the importance of predicting sensitivity. As in the example of BMS-754807, ITGA9, SMAD1, ASAP1, CCL20, PTPRM, MAPK11, RRAS2, NRAS, MYB, TPR, SDC3, TNF, PTEN, REPS2, ADCY8, SRC, CXCR6, CDH4, PDE3B, SOCS1, RHO, ILK, and MYLK are at the top of the list, with SRC, PTEN, SOCS1 and NRAS being direct neighbors of the known drug target IGF1 R. The most enriched KEGG pathway of those proteins is focal adhesion (marked as red balls in FIG. 13), which is known to be involved in cell proliferation. IGFIR bears a tyrosine residue, which upon phosphorylation confers enzymatic activity to the Src tyrosine kinase providing a potential link to cancerogenesis.

In certain embodiments, the methods of presently disclosed subject matter can be applied to the analysis of expression data from patients. In certain embodiments, the method can be used to reveal mechanisms of action of certain drugs. In certain embodiments, the method can provide insights for precision usage of drugs in individual patients with distinguishing genetic markers.

The description herein merely illustrates the principles of the disclosed subject matter. Various modification and alterations to the described embodiments will be apparent to those skilled in the art in view of the teachings herein. Accordingly, the disclosure herein is intended to be illustrative, but not limiting, of the scope of the disclosed subject matter.

1. A method for predicting a drug response in cancer patients and cancer cell lines using genomic and expression data, comprising:
applying a diffusion kernel based on a plurality proteins/genes in an interaction database to measure a closeness between the first protein and each of the plurality of genes, respectively;
ranking each of the plurality of genes;
selecting one or more genes from the ranking, each having a ranking above a threshold; and
predicting a response of cancer patients or cancer cell lines to the drug based on the selected one or more genes.

2. The method of claim 1, wherein the predicting comprises using a machine learning system.

3. The method of claim 1, wherein the effect comprises an inhibiting effect.

4. The method of claim 1, wherein the drug comprises BMS-754807 and the first protein/gene comprises insulin-like growth factor-IR/IR (IGF1R).

5. The method of claim 1, wherein the interaction database comprises a Search Tool for the Retrieval of Interacting Genes/Proteins network (“STRING NETWORK”).

6. The method of claim 5, wherein the diffusion kernel represents a continuous time limit of a lazy random walk.

7. The method of claim 6, wherein the continuous time limit of a lazy random walk is defined by:
$$K = {e}^{β H} = I + β H + \frac{{β}^{2}}{2 !} {H}^{2} + …$$
wherein H is a negative Laplacian matrix defined on an adjacent matrix as obtained from the STRING network.

8. The method of claim 1, wherein the ranking is based at least in part on the closeness.

9. The method of claim 1, wherein the ranking is based at least in part on a spearman correlation.

10. The method of claim 2, wherein the machine learning system is a least absolute shrinkage and selection operator (“LASSO”) regression.

11. The method of claim 10, wherein the LASSO regression is an alternative regularized version of least squares.

12. The method of claim 11, wherein y=(y₁, . . . , yₙ) represents drug sensitivity of different cell lines;
x₁=(xᵢ₁, . . . , xᵢₘ)′, (i=1, . . . , n) represents features of an ith cell line; and
wherein the LASSO regression comprises solving:
$${min}_{{α}_{0} , α} ( \frac{1}{2 n} {\sum }_{i = 1}^{n} {( {y}_{i} - {α}_{0} - {x}_{i}^{′} α )}^{2} + λ {\sum }_{j = 1}^{m} \vert {α}_{j} \vert )$$
where λ is a nonnegative regularization parameter.

13. The method of claim 1, further comprising bootstrapping.
